(19) United States
(12) Patent Application Publication
(10) Pub. No.: US 2016/0326905 A1
(43) Pub. Date: Nov. 10, 2016

(54) VIBRATION DAMPING ASSEMBLY FOR A PIPING UNIT

(71) Applicant: GENERAL ELECTRIC COMPANY, Schenectady, NY (US)

(72) Inventors: Hua ZHANG, Greer, SC (US); Rui LI, Shanghai (CN); Liming WEI, Shanghai (CN); Qianhong FENG, Shanghai (CN); Jianwei SHAO, Shanghai (CN)

(21) Appl. No.: 15/109,156

(22) PCT Filed: Jan. 9, 2014
(86) PCT No.: PCT/CN2014/070349

§ 371 Date: Jun. 30, 2016

(51) Int. Cl. F01D 25/04; F16F 15/02; F02C 7/232; F02C 3/04; F02C 7/22; F16F 7/10; F16L 55/033

(52) U.S. Cl. CPC F01D 25/04; F16F 7/10; F16F 15/02; F16L 55/0335; F02C 3/04; F02C 7/222; F02C 7/232; F05D 2220/32; F05D 2240/35; F05D 2260/96

(57) ABSTRACT

A vibration damping assembly for a piping unit includes a first pipe portion extending from an inlet to a first valve. Also included is a second pipe portion extending from the first valve to a second valve. Further included is a third pipe portion extending from the second valve to an outlet. Yet further included is at least one ring structure surrounding a portion of an outer surface of at least one of the first pipe portion, the second pipe portion and the third pipe portion, the at least one ring structure disposed in contact with the outer surface to damp vibration associated with the piping unit during operation.

### BACKGROUND OF THE INVENTION

The subject matter disclosed herein relates to piping units and, more particularly, to a vibration damping assembly for a piping unit.

Gas turbine engines require a fuel to be supplied to a combustor assembly for mixture with compressed air. The mixture of fuel and compressed air is combusted and routed to a turbine for conversion to mechanical work to be imparted on a shaft. In gas turbine syngas applications, such as integrated gasification combined cycle (IGCC) and blast furnace gas (BFG) applications, the fuel is supplied via a piping unit that can be rather large and prone to vibration issues during operation. The issues associated with excessive vibration can affect reliability and availability of a power plant that the gas turbine engine is associated with.

### BRIEF DESCRIPTION OF THE INVENTION

According to one aspect of the invention, a vibration damping assembly for a piping unit includes a first pipe portion extending from an inlet to a first valve. Also included is a second pipe portion extending from the first valve to a second valve. Further included is a third pipe portion extending from the second valve to an outlet. Yet further included is at least one ring structure surrounding a portion of an outer surface of at least one of the first pipe portion, the second pipe portion and the third pipe portion, the at least one ring structure disposed in contact with the outer surface to damp vibration associated with the piping unit during operation.

According to another aspect of the invention, a gas turbine engine includes a compressor section, a turbine section and a combustor assembly. Also included is a fuel delivery assembly configured to route fuel to the combustor assembly. The fuel delivery assembly includes a plurality of pipe portions operatively coupled to each other to form a pipeline between a fuel inlet and a fuel outlet in fluid communication with the combustor assembly. The fuel delivery assembly also includes a first valve configured to regulate a flow rate of fuel in the pipeline. The fuel delivery assembly further includes a second valve located downstream of the first valve. The fuel delivery assembly yet further includes at least one ring structure surrounding a portion of an outer surface of the pipeline, the at least one ring structure disposed in contact with the outer surface to damp vibration associated with the pipeline during operation of the fuel deliver assembly.

These and other advantages and features will become more apparent from the following description taken in conjunction with the drawings.

### BRIEF DESCRIPTION OF THE DRAWINGS

The subject matter, which is regarded as the invention, is particularly pointed out and distinctly claimed in the claims at the conclusion of the specification. The foregoing and other features, and advantages of the invention are apparent from the following detailed description taken in conjunction with the accompanying drawings in which:

FIG. 1 is a schematic illustration of a gas turbine engine;

FIG. 2 is a schematic illustration of a piping unit for delivering fuel to a combustor assembly of the gas turbine engine;

FIG. 3 is a perspective view of a vibration damping assembly operatively coupled to the piping unit; and

FIG. 4 is a segment of the vibration damping assembly.

The detailed description explains embodiments of the invention, together with advantages and features, by way of example with reference to the drawings.

### DETAILED DESCRIPTION OF THE INVENTION

The terms “axial” and “axially” as used in this application refer to directions and orientations extending substantially parallel to a center longitudinal axis of a turbine system. The terms “radial” and “radially” as used in this application refer to directions and orientations extending substantially orthogonally to the center longitudinal axis of the turbine system. The terms “upstream” and “downstream” as used in this application refer to directions and orientations relative to an axial flow direction with respect to the center longitudinal axis of the turbine system.

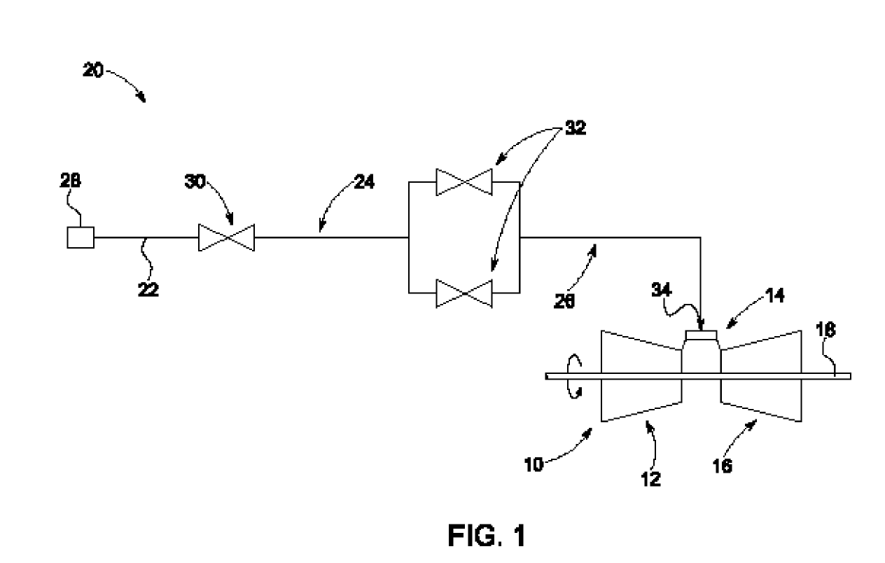

Referring to FIG. 1, a gas turbine engine 10, constructed in accordance with an exemplary embodiment of the invention, is schematically illustrated. The gas turbine engine 10 includes a compressor section 12, a combustor assembly 14, a turbine section 16, a shaft 18 and a fuel delivery assembly 20 in the form of a piping unit. It is to be appreciated that one embodiment of the gas turbine engine 10 may include a plurality of compressor sections 12, combustor assemblies 14, turbine sections 16, and shafts 18. The compressor section 12 and the turbine section 16 are coupled by the shaft 18. The shaft 18 may be a single shaft or a plurality of shaft segments coupled together to form the shaft 18.

In operation, air flows into the compressor section 12 and is compressed into a high pressure gas. The high pressure gas is supplied to the combustor assembly 14 and mixed with fuel, for example process gas and/or synthetic gas (syngas). Alternatively, the combustor assembly 14 can combust fuels that include, but are not limited to natural gas and/or fuel oil. The fuel/air or combustible mixture is ignited to form a high pressure, high temperature combustion gas stream. Thereafter, the combustor assembly 14 channels the combustion gas stream to the turbine section 16, which coverts thermal energy to mechanical, rotational energy.

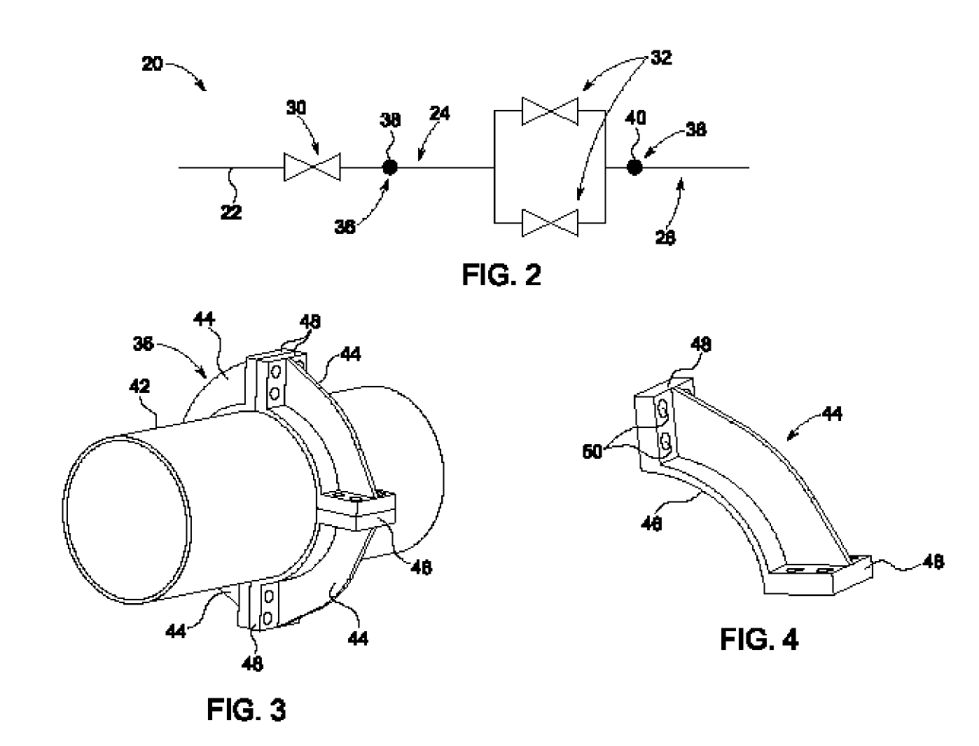

Referring now to FIG. 2, with continued reference to FIG. 1, the fuel delivery assembly 20 comprises a plurality of pipe segments joined together to form a continuous passage for the routing of fuel to the combustor assembly 14. In one embodiment, the plurality of pipe segments comprises a first pipe segment 22, a second pipe segment 24 and a third pipe segment 26. It is to be understood that each of the specified segments may be further segmented into additional sub-segments, but for purposes of description, reference is simply made to the respective pipe segments. The first pipe segment 22 extends from a fuel inlet 28 that is in fluid communication with a supply of fuel to a first valve 30. The first valve 30 may be any type of valve suitable to regulate the flow of fluid within the fuel delivery assembly 20. In one embodiment, the first valve 30 is a stop ratio valve. The second pipe segment 24 extends from the first valve 30 to a second valve arrangement 32. The second valve arrangement 32 comprises at least one, but typically a plurality of second valves configured to control the flow of fuel. In the illustrated embodiment, two second valves are illustrated, but it is to be appreciated that more valves may be included. Irrespective of the precise number of second valves in the second valve arrangement 32, the second valves are arranged in parallel. In one embodiment, the second valves are gas control valves. The third pipe segment 26 extends from the second valve arrangement 32 to a fuel outlet 34 in fluid communication with the combustor assembly 14. More specifically, the fuel outlet 34 is in fluid communication with one or more fuel nozzles, such as a fuel injection manifold (not illustrated) of the combustor assembly 14.

During operation of the fuel delivery assembly 20, vibration characteristics of the plurality of pipe segments must be monitored to ensure that excessive vibration amplitude is not encountered, such as that observed at resonant frequencies of the piping. In order to damp structural vibration of the plurality of pipes, at least one ring structure 36 is included around one or more axial locations of the first pipe segment 22, the second pipe segment 24, and/or the third pipe segment 26. The at least one ring structure 36 may be placed in various locations along the length of the piping. In the illustrated embodiment (FIG. 2), a first ring structure 38 is disposed between the first valve 30 and the second valve arrangement 32. The illustrated embodiment also includes a second ring structure 40 located downstream of the second valve arrangement 32. Although illustrated as such, it is to be understood that the number of ring structures may be more or less than that illustrated and may be located in different axial locations along the first pipe segment 22, the second pipe segment 24 and the third pipe segment 26. In one embodiment relating to the first ring structure 38, the first ring structure 38 is located at about a mid-axial distance between the first valve 30 and the second valve arrangement 32. In one embodiment relating to the second ring structure 40, the second ring structure 40 is located about one-half of a diameter of the third pipe segment 26 from the second valve arrangement 32.

Referring now to FIGS. 3 and 4, structural detail of the at least one ring structure 36 is illustrated in greater detail. Although it is contemplated that the at least one ring structure 36 is integrally formed with one of the pipe segments, typically the at least one ring structure 36 is operatively coupled to an outer surface 42 of the piping. Coupling the at least one ring structure 36 facilitates adjustability of the ring structure, which advantageously allows for adjustment based on various analysis tests that may be conducted, such as piping structural modal analysis or ping tests which can provide information about the most beneficial location for the ring structure to be disposed on the piping. In the illustrated embodiment, the at least one ring structure 36 includes a plurality of ring segments 44. The number of the plurality of ring segments 44 may vary depending on the particular application. As shown the overall ring structure may be segmented into quadrants, such that four quarter portion segments are included (FIG. 4). Alternatively, two half portion segments may be included to form the ring structure. These are merely exemplary embodiments and the precise number may vary.

Each of the plurality of ring segments 44 include a radially inner surface 46 that is placed into contact with the outer surface 42 of the piping and subsequently tightened thereon, as will be described in detail below. Each ring segment includes a pair of flanges 48 at end regions of the respective ring segments. The pair of flanges 48 have through holes 50 configured to receive a mechanical fastener (not illustrated) therein to facilitate attachment to an adjacent ring segment. The number of through holes 50 may vary. In the illustrated embodiment, four such holes are included. The through holes 50 may be threaded to facilitate engagement of the mechanical fastener or may be a pure hole without threading. In either event, flanges of adjacent ring segments are placed in close proximity and fastened together with one or more fasteners extending through the through holes 50. A nut (not illustrated) may be included to enhance the rigidity of the attachment. As noted above, the number of the plurality of ring segments 44 may vary. Irrespective of the precise number of ring segments, it is to be appreciated that the segments form a continuous ring around the outer surface 42 of the piping and is tightened thereto to abate piping structural vibration during operation of the fuel delivery assembly 20. The at least one ring structure 36 that is formed by the plurality of ring segments 44 is adjustable in many ways due to the plurality of ring segments 44. Specifically, the plurality of ring segments 44 may be adjusted to provide a different tightness on the piping and may be rotated to provide different dampening characteristics. Additionally, the at least one ring structure 36 is easily moved from one axial location along the piping to another, which may be beneficial after analysis of piping vibration during operation with the at least one ring structure 36 fixed thereon. The ring structures 36, 38, 40 may be fixed to the piping surface by means of welding.

Advantageously, the embodiments described above dampen vibration of the piping of the fuel delivery assembly 20, particularly during excessive vibration events, such as those caused by strong turbulence flow as one or more valves close. This reduces the likelihood of fatigue failure and increases overall power plant reliability. Additionally, the at least one ring structure 36 can be implemented onto existing systems to reduce flow induced vibrations.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

1. A vibration damping assembly for a piping unit comprising:
a first pipe portion extending from an inlet to a first valve;
a second pipe portion extending from the first valve to a second valve;
a third pipe portion extending from the second valve to an outlet; and
at least one ring structure surrounding a portion of an outer surface of at least one of the first pipe portion, the second pipe portion and the third pipe portion, the at least one ring structure disposed in contact with the outer surface to damp vibration associated with the piping unit during operation.

2. The vibration damping assembly of claim 1, wherein at least one ring structure comprises a plurality of ring segments mechanically coupled to each other.

3. The vibration damping assembly of claim 2, wherein the plurality of ring segments are mechanically coupled with a plurality of fasteners extending through respective flanges of the plurality of ring segments.

4. The vibration damping assembly of claim 2, wherein the plurality of ring segments are adjustable.

5. The vibration damping assembly of claim 2, wherein the plurality of ring segments comprises two half portion segments.

6. The vibration damping assembly of claim 2, wherein the plurality of ring segments comprises four quarter portion segments.

7. The vibration damping assembly of claim 1, wherein the second pipe portion extends between the first valve and a plurality of second valves arranged in parallel, wherein the at least one ring structure is located along the second pipe portion.

8. The vibration damping assembly of claim 7, wherein the at least one ring structure is located at an axial location about halfway between the first valve and the plurality of second valves.

9. The vibration damping assembly of claim 1, wherein the third pipe portion extends between a plurality of second valves arranged in parallel and the outlet, wherein the at least one ring structure is located at an axial distance away from the plurality of second valves that is about one-half of a diameter of the third pipe portion.

10. The vibration damping assembly of claim 1, wherein the piping unit is configured to route a fuel to a combustor assembly of a gas turbine engine.

11. The vibration damping assembly of claim 10, wherein the fuel comprises syngas.

12. A gas turbine engine comprising:
a compressor section;
a turbine section;
a combustor assembly; and
a fuel delivery assembly configured to route fuel to the combustor assembly, the fuel delivery assembly comprising:
a plurality of pipe portions operatively coupled to each other to form a pipeline between a fuel inlet and a fuel outlet in fluid communication with the combustor assembly;
a first valve configured to regulate a flow rate of fuel in the pipeline;
a second valve located downstream of the first valve; and
at least one ring structure surrounding a portion of an outer surface of the pipeline, the at least one ring structure disposed in contact with the outer surface to damp vibration associated with the pipeline during operation of the fuel deliver assembly.

13. The gas turbine engine of claim 12, wherein at least one ring structure comprises a plurality of ring segments mechanically coupled to each other.

14. The gas turbine engine of claim 13, wherein the plurality of ring segments are mechanically coupled with a plurality of fasteners extending through respective flanges of the plurality of ring segments.

15. The gas turbine engine of claim 13, wherein the plurality of ring segments are adjustable.

16. The gas turbine engine of claim 13, wherein the plurality of ring segments comprises two half portion segments.

17. The gas turbine engine of claim 13, wherein the plurality of ring segments comprises four quarter portion segments.

18. The gas turbine engine of claim 12, wherein the plurality of pipe portions comprises a first pipe portion extending between the fuel inlet and the first valve, a second pipe portion extending between the first valve and the second valve, and a third pipe portion extending between the second valve and the fuel outlet, wherein the at least one ring structure comprises a first ring structure operatively coupled to the second pipe portion.

19. The gas turbine engine of claim 18, further comprising a second ring structure operatively coupled to the third pipe portion.
